(19) United States
(12) Patent Application Publication
(10) Pub. No.: US 2025/0179873 A1
(43) Pub. Date: Jun. 5, 2025

(54) UTILIZATION OF STATIC STRUCTURES IN ADVANCED BUILDING ENVELOPE SYSTEMS TO IMPROVE LIGHTING, THERMAL, ACOUSTIC, AND STORM PROTECTION PERFORMANCE

(71) Applicant: UNIVERSITY OF FLORIDA RESEARCH FOUNDATION, INCORPORATED, Gainesville, FL (US)

(72) Inventors: Ryan SHARSTON, Gainesville, FL (US); Manan Singh RAGHUVANSHI, Gainesville, FL (US)

(21) Appl. No.: 18/904,760

(22) Filed: Oct. 2, 2024

Related U.S. Application Data
(60) Provisional application No. 63/587,222, filed on Oct. 2, 2023.

(51) Int. Cl. E06B 9/24; E04B 1/88

(52) U.S. Cl. CPC E06B 9/24; E04B 1/88; E06B 2009/2494

(57) ABSTRACT

A building envelope system. The building envelope system includes a plurality of shading modules for installing over fenestrations of a structure. Parameters of the shading modules are selected to optimize certain indoor environmental quality parameters. The optimized shading module parameters include: size, shape, geometry, orientation, number, placement, and material. The optimization process further includes consideration of the geographical location of the structure and a compass facing direction of each fenestration. The indoor environmental quality parameters include maximizing spatial daylight autonomy (SDA), minimizing annual sun exposure (ASE), and minimizing daylight glare probability.

### CROSS REFERENCE TO RELATED APPLICATIONS

The present application claims priority under 35 U.S.C. 119 (e) to the provisional patent application filed on Oct. 2, 2023 and assigned application No. 63/587,222. The provisional application is incorporated herein its entirety.

### BACKGROUND

The impact of building fenestrations (i.e., the arrangement of windows and doors on the elevations of a building) on energy performance and indoor environmental quality (IEQ) of the building is well known. Acting as the “exchange agent” between indoor and outdoor environments, building fenestrations are responsible for a majority of the thermal interactions that take place between the interior of a building structure and the exterior natural environment.

Therefore, improvements in the performance of the fenestrations are critical to achieving improved energy performance and IEQ in buildings. In fact, due to their significant interactions with the ambient conditions, there has been tremendous interest in harnessing roofs, skylights, and fenestrations, such as windows, (see, for example, Debije, 2010; Gutierrez & Lee, 2013; Gutierrez & Zohdi, 2014) in the push for buildings with a higher energy performance rating.

Building fenestrations also have undeniable impacts on daylight admission, and consequently, indoor environmental conditions. Among all contributions that building fenestration have on the indoor environmental quality, the control of admitted daylight is particularly important, given the extensive effects that daylight can have on the health and well-being of the building occupants.

To capitalize on these effects, building designers and engineers have developed “intelligent” building fenestration systems, where the building components, such as shading systems, are designed in accordance with expected outdoor environmental conditions.

Prominent interactions between the building and the external environment render the building envelope as the crucial element regarding resilience and energy conservation. Hence, there has been considerable research to advance building envelope technologies to improve IEQ and save energy. However, the latest developments in the field are segregated, mainly because the different functionalities of envelope systems such as shading, daylighting, and insulation are considered as independent goals, each addressed separately by different technologies.

To elaborate, most building envelope systems focus on specific objectives pertinent to one of shading, daylighting, or thermal insulation (Kosir, 2016). Only a few attempts, such as the “Energy Frames” and “Climate Adaptive Building Facades” have attempted to merge different functionalities into a single system (Loonen et al., 2013; Johnsen & Winther, 2015). Therefore, to achieve energy-efficient improvements in IAQ and resilience, the current market status requires the user to install multiple facade technologies, such as insulating windows, shading devices, PV cells, and storm shutters, resulting in high installation costs and frequent maintenance issues.

### SUMMARY

Due to the inherently higher U-values (i.e., thermal transmittance ratings or the rate of transfer of heat), through the walls of a structure, heat transfer between the interior and exterior of a building occurs primarily through fenestrations, mainly windows. As a result, an effective shading structure (also referred to herein as a building envelope system) that provides sufficient illuminance levels, mitigates heat transfer through the building envelope, and ensures acceptable visual and environmental comfort within the structure by controlling the glare, is highly desirable. Specifically, these technical parameters are referred to as: spatial daylight autonomy, annual sun exposure, and daylight glare probability.

In one embodiment of the present invention, the building envelope system comprises a plurality of computer-generated optimal geometric structural shapes. With these structural shapes in place, the building envelope system simultaneously provides sufficient daylight within the structure, while avoiding glare and mitigating excessive heat transfer between the interior and exterior spaces. In one embodiment the structural shapes are passive, that is, they do not provide other functions, such as generating electricity.

Optimization of the structural shapes (referred to as modules, shading modules or fenestration modules herein) to improve building energy and IEQ performance has been achieved through a mixed-method study, including simulation (Grasshopper-based optimization of the building envelope system) and a physical mock-up experiment to verify the simulation results.

Experimental results for one building showed that the proposed building envelope system caused the average indoor illuminance to decrease by 53%, 54.8%, and 76% at 8 AM, 12 PM, and 4 PM, respectively, leading to better visual comfort for the building occupants. Furthermore, the building envelope system on the east façade, south façade, and west façade reduced the indoor surface temperature by 46.8%, 33.1%, and 32.3%, respectively, leading to improved thermal comfort for the occupants.

The building envelope system (e.g., placement and shape of the shading modules) is designed to optimize several IEQ performance metrics (such as shading, insulation, and storm protection), which is better, simpler, and less expensive to design and maintain than using multiple building envelope systems and multiple shapes and sizes for the shading modules, with each system designed to improve one IEQ parameter. Overall, the use of a single building envelope system designed to optimize several IEQ parameters is more cost effective in terms of construction, labor, and long-term maintenance.

### BRIEF DESCRIPTION OF THE DRAWINGS

The present embodiments are illustrated by way of example, and not by way of limitation, in the figures of the accompanying drawings.

The following figures are illustrative only and not intended to be limiting.

FIGS. 1-4 illustrate two different structural shapes for use as a shading module in the building envelope system of the present invention, shown under compression and tension forces.

FIG. 5 illustrates a flow chart for determining a building envelope system according to one embodiment of the present invention.

FIGS. 6A and 6B illustrate an experimental real-world mock-up structure for use in measuring various indoor environmental quality parameters associated with the building envelope system of the present invention.

FIGS. 7A and 7B each illustrate a computer simulation of static building envelope system according to one embodiment of the present invention.

FIGS. 8A and 8B are a series of bar charts comparing simulated and actual illuminance values. FIG. 8A evaluates illuminance of shading off or shading on at 8 AM and 12 PM. FIG. 8B shows illuminance with shading off or shading on at 4 PM.

FIGS. 9A and 9B are graphs illustrating hourly temperature values for a simulated and actual implementation of a building envelope system according to one embodiment of the invention. FIG. 9A includes hourly delta temperature readings between simulation and measurements at multiple daily times over the course of six days. FIG. 9B includes hourly delta temperature readings between simulation and measurements at multiple daily times over the course of six days following the days in FIG. 9A.

FIGS. 10A-10C illustrate, respectively, a plurality of thermal images depicting surface temperatures on the east façade, the south façade, and the west façade of the mock-up structure at various times of the three days indicated.

FIG. 11 illustrates the results of surface temperature measurements for the different-facing facades after installation of a building envelope system according to the present invention.

FIG. 12 illustrates the user of different module shapes on two different surfaces of a structure.

FIG. 13 illustrates a computer system for practicing the present invention.

### DETAILED DESCRIPTION

### Definitions

Unless defined otherwise, all technical and scientific terms used herein have the same meaning as commonly understood by one of ordinary skill in the art to which this invention pertains. Although any methods and materials similar or equivalent to those described herein can be used in the practice or testing of the invention, the preferred methods and materials are now described. All publications mentioned herein are incorporated herein by reference.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Reference throughout this specification to “one embodiment”, “an embodiment,” “an example embodiment,” means that a particular feature, structure, or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment but may. Furthermore, the particular features, structures or characteristics may be combined in any suitable manner, as would be apparent to a person skilled in the art of this disclosure, in one or more embodiments. Furthermore, while some embodiments described herein include some, but not other features included in other embodiments, combinations of features of different embodiments are meant to be within the scope of the invention. For example, in the appended claims, any of the claimed embodiments can be used in any combination.

### DESCRIPTION OF THE INVENTION

In a static embodiment, the present invention is directed to a computer-designed building envelope system that optimizes the effects on illuminance levels, surface temperature, and glare in indoor spaces. Additionally, the static envelope system helps distribute the daylight throughout the building and provides protection for the building windows during natural hazards, namely hurricanes. The first such system is designed for implementation in the City of Gainesville, Florida; the system is locale dependent. A preferred shading module (also referred to as a shading structure or a fenestration module) and a building envelope system comprising a plurality of such shading modules configured in an advantageous pattern, was determined based on a computational optimization analysis. Its illuminance performance was validated through a mixed-method study, including a simulation (Grasshopper-based optimization) and physical experiments (i.e., using a 1.8 m×1.8 m×2 m mock-up structure in the City of Gainesville, Florida).

The present invention identifies a preferred building envelope system, particularly in terms of a geometry for the individual modules and a pattern of those modules on each surface of the building. The preferred building envelope system provides sufficient illuminance within the structure, while improving IEQ and minimizing glare.

The algorithm for determining the preferred shape and preferred placement of the shading modules also considers the orientation of each building façade. For example, the sun position and thus the sun exposure of a façade typically generates a unique shading module for that façade.

### Geometry of the Shading Structures

As described further herein, various shapes and materials can be used for shading module as determined by an optimization process. The optimization process begins by determining a basic shape/geometry, and then, the computer software optimizes that basic shape/geometry according to the various parameters and metrics described herein. Specifically, the following characteristics of the shading modules are evaluated and optimized as the algorithm executes: the shape of each shading module and overall shape of the building envelope system, placement of each shading module within the building envelope system, the area covered by each shading module and the total area covered by the building envelope system, the material of each shading module, and the distance between the fenestration and the shading module.

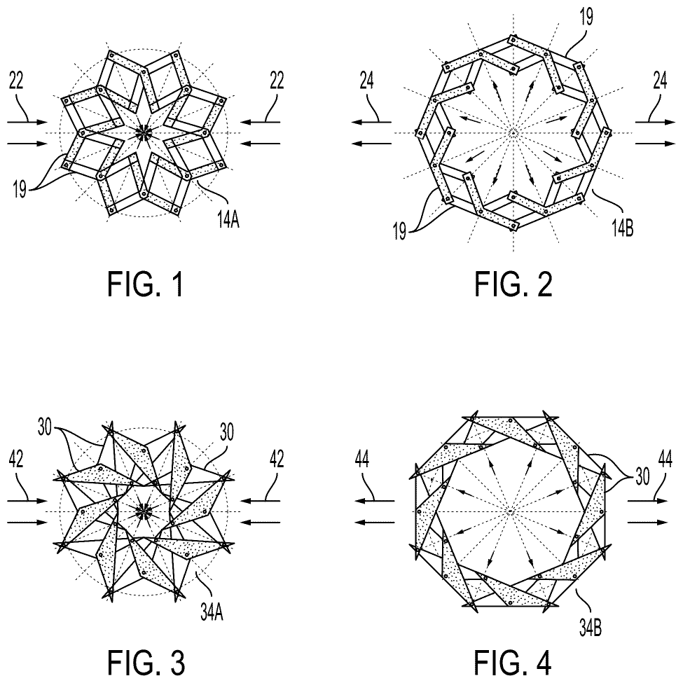

FIGS. 1 and 2 illustrate candidate a shading module 14A/14B comprising a plurality of interconnected linear elements 19. The module 14 A is under compression, as indicated by arrowheads 22, and the shading module 14B is under tension as indicated by arrowheads 24. The process of designing the shading module 14A/14B began with two pivotably connected linear elements and progressed by adding additional linear elements, pivotably connected to the existing structure.

To increase the coverage area, in another embodiment the basic element geometry comprises a triangle, in lieu of the linear element 19, and hence, increases the coverage area beyond the linear-element based modules of FIGS. 1 and 2.

FIGS. 3 and 4 illustrate such a shading module with increased coverage area. The module 34A/34B comprises a plurality of interconnected triangular elements 30. The shading module 34A is under compression as indicated by arrowheads 42 and the shading module 34B is under tension as indicated by arrowheads 44. Again, the process of designing the shading module 34A/34B began with two pivotably connected triangular elements and progressed by adding additional triangular elements, pivotably connected to the existing structure.

Reference to the shading modules under compression or tension, as depicted in FIGS. 1-4 is more figurative than literal, as the tension and compression configurations illustrate how the algorithm expands or contracts the modules in an effort to satisfy the design criterial related to maximizing spatial daylight autonomy (SDA), minimizing annual sun exposure (ASE), and minimizing daylight glare probability.

The computer algorithm of the present invention determines, among other parameters, determines the fenestration area that should be covered by shading modules. In one embodiment the module 34A/34B is used. Based on the area to be covered (or conversely, the area to be open) the appropriate tensile or compressive force is applied to create a central opening of the desired area and the module elements are secured to remain in that configuration.

Although the embodiment of FIGS. 1 and 2 based on a linear element and the embodiment of FIGS. 3 and 4 based on a triangular element undergo similar construction processes, the additional surface area provided by the embodiments of FIGS. 3 and 3 provide greater shading and therefore better daylight control within the structure.

Additionally, the pattern or shape of the shading module, as described above, can be created using the following equation to find the number of vertices and angles:

$$No . of vertices = 360 ° / ( 180 ° - Angle ) = 360 ° / ( 180 ° - 135 ° ) = 8 \qquad ( 1 )$$

Table 1 shows an efficiency comparison between the linear element module of FIGS. 1 and 2 and the triangle element module of FIGS. 3 and 4.

TABLE 1
Efficiency comparison between two geometrical
structural patterns (shapes)

| | | | Area | Area | Window | |
|---|---|---|---|---|---|---|
| | | No. of | enclosed | open | Length | Area % |
| | Angle | Angles | (m²) | (m²) | (m) | Decrease |
| Pattern I | 135 | 8 | 0.032 | 0.044 | 1.62 | 27.03 |
| Pattern II | 135 | 8 | 0.045 | 0.064 | 2.05 | 30 |

The “Area enclosed” represents the window area covered by the shading structure. “Area open” indicates the window area that is not shaded and therefore is admitting daylight into the structure. “Window length” and “Area % Decrease” indicate the length dimension of the fenestration and the percentage of fenestration coverage, respectively.

As shown, Pattern II (the geometry of the module 34A/34B in FIGS. 3 and 4) provides 3% more efficiency than the Pattern I (the geometry of the module 19A/19B of FIGS. 1 and 2) based on the last column of Table 1. In fact, Pattern II leads to a higher efficiency since its four modules cover a larger fenestration area and create a greater degree of shading. Therefore, Pattern II is the preferred embodiment as between Pattern I and Pattern II.

In one embodiment, a material of the shading modules comprises aluminum. However, the algorithm can also determine a preferred material based on optimizing, minimizing, or maximizing, the desired insulating and reflective properties of the shading modules.

Additionally, the shading modules of the present invention provide insulation between the exterior and interior environments as air is retained between the shading modules and the fenestration.

In lieu of the Pattern I or Pattern II shading modules identified above the computer algorithm can determine optimum shaped modules for use on one surface of the structure with differently shaped modules employed on the other surfaces. The shading modules can be mounted in close contact or spaced apart, again, as determined by the algorithm optimization results.

### Simulation

In the static embodiment, an optimum configuration of shading geometry is calculated for a given geographical location, that is, the shading geometry is customized for a specific location. The shading module geometry (shape, size, etc. of each shading module) is also different dependent on the facing or compass direction of the fenestration over which the shading module is installed.

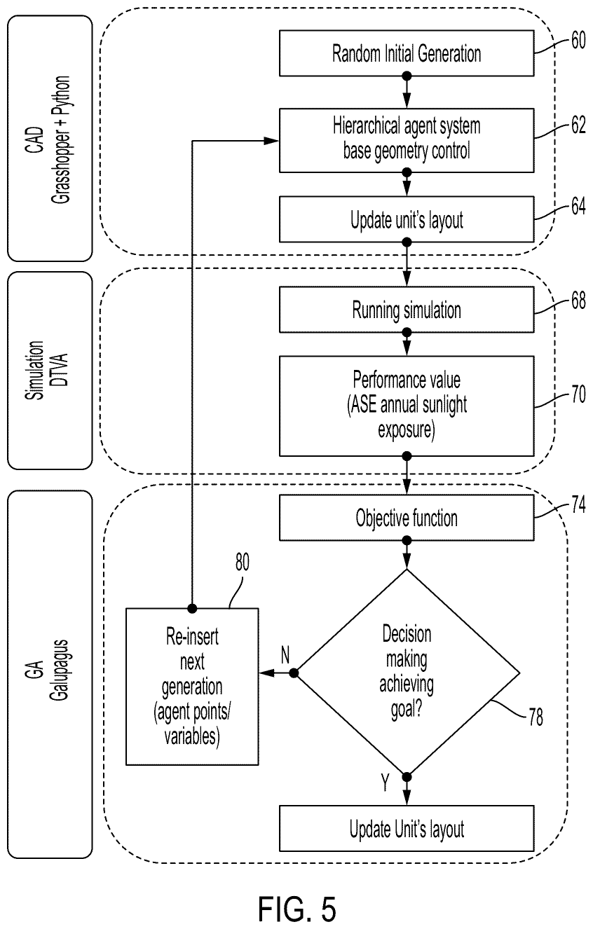

To find the optimal location-dependent and facing-dependent configuration, the system optimization and simulation processes are shown in the FIG. 5 flowchart. Initially, random agent point values for the shading modules are generated at a step 60 and passed to a hierarchical agent point system in a CAD model at a step 62 for updating the configuration of the building envelope system and its constituent shading modules at a step 64.

At a step 68 a simulation is executed and at a step 70 several performance values are determined, including: the annual daylight accessibility received at each measurement node of the structure, the Spatial Daylight Autonomy (sDA) value, the Annual Sun Exposure (ASE) value, and the Daylight Glare Probability (DGP) are determined.

An objective function 74 is indicated as an input to a decision step 78 where an evaluation process is executed to determine whether the calculated values satisfy performance goals as set forth in an objective function. If one or more of the performance goals are not satisfied, a reproduction/iteration process begins at a step 80 where new agent point values (referred to as offspring) are selected and execution returns to the step 62.

The new point values are passed to the CAD model at the step 62 to update the system using these new agents point values at the step 64. At the step 68 the simulation program is executed and new performance values are generated at the step 70 based on the offspring agent point values. As before, these performance values are used in the evaluation process at the step 78.

Additional iterations are executed until either the objective function value is satisfied, or the maximum number of iterations have been conducted. Yi et al. (2019) utilized a similar methodology to investigate the effect of auxetic structures in various U.S. climates using various simulation methodologies.

To implement the simulation processes of the invention, one embodiment utilizes Grasshopper, a CAD plugin tool, referred to as Rhinoceros (Robert McNeel & Associates, 2017), to update the building envelope system and its constituent shading modules.

The Spatial Daylight Autonomy (sDA) metric (a preferred performance measure for spatial daylight) measures how much of an interior space receives sufficient daylight. Specifically, it describes the percentage of the structure's floor area that receives at least 300 lux for at least 50% of the annual occupied hours. Thus, this metric indicates a percentage of the floor space that receives at least 300 lux for 50% of the occupied hours.

During the simulation process, to calculate the sDA at each measured point within the structure, in one embodiment a tool known commercially as DIVA (Solemma, 2017) utilizes a Radiance tool to predict several measures of daylight based on sky conditions acquired from location-specific meteorological data. The simulation process tests, and analyzes the data at least twice before and after each new shading structure is created. Specifically, within the simulation process an optimization subprocess, of which sDA is an element, simulates a baseline (without shading) and then simulates a proposed building envelope with the optimized shading geometry in place. The baseline configuration is run once and the simulation and optimization processes execute on proposed building envelopes in accordance with the stated optimization equation (until reaching a −1 result, see Equation (6) below). Then, the simulation processes assess the final thermal and lighting performance of the proposed building envelope.

In addition to the sDA value, in a similar fashion the system determines and utilizes Annual Sun Exposure (ASE) and Daylight Glare Probability (DGP) measurements.

The ASE represents a percentage of an area that has had an illuminance level higher than 1000 lux for more than 250 hours a year.

The DGP metric indicates the percentage probability of glare occurrence. Wienold (2009) defines DGP≤35% as “class A”, which is the best class, where 95% of the time the office is used, glare is weaker than “imperceptible”. Therefore, in this study DGP of 35% was chosen as the glare criterion.

For optimization purposes, the inventive system uses another Grasshopper tool known commercially as Galapagos, which is the built-in optimization application for Grasshopper.

### Analysis of Simulation and Experimental Results

To thoroughly and accurately test the final optimized building envelope system, the inventor compared the baseline system (i.e., without shading structures in place), simulation results, and experimental results from a mock-up structure. Then the inventor optimized the building envelope system and implemented this optimized building envelope system on the mock-up structure. Again, the results from the simulated study and the mock-up were compared to verify the effectiveness of the building envelope system.

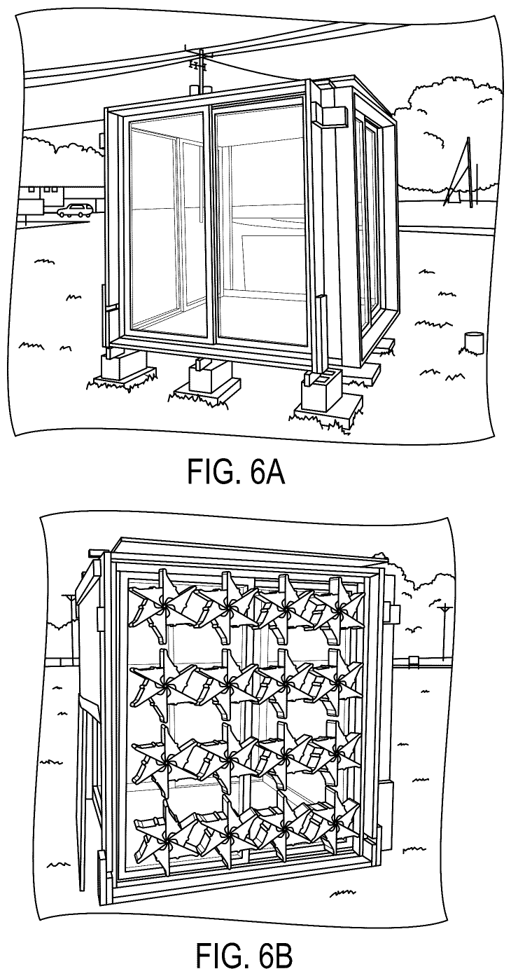

A mock-up office space in the University of Florida (UF)'s Energy Research and Education Park (see FIGS. 6A and 6B) served as the test case for assessing the effectiveness of the inventive system. The mock-up is 1.8 m×1.8 m with a height of 2 m and has openings (glazing surfaces) with south, west, and east orientations. FIG. 6A illustrates an exterior view of the baseline structure and FIG. 6B illustrates the west-facing façade with building envelope elements.

Daylight performance parameters, including sDA, ASE, and DGP were measured on the mock-up structure without the shading structure in place. The measurements included lighting levels, surface and air temperatures, and glare. These measurements created a baseline control case.

The mock-up structure, without the building envelope system in place, was also simulated. The simulation results and the mock-up experimental results (both without the building envelope system in place) were compared to verify the accuracy of the simulation.

The optimized building envelope system (optimized as described below) was then added to the south, east, and west-oriented façades of the mock up and the performance parameters of sDA, ASE, and DGP were again measured. Again, for use in verifying the simulated results with the optimized building envelope system in place.

Computer software optimized the building envelope system by expanding, contracting, and/or changing the shape of the shading elements based on the simulated values and the outcome of the objective function that considered the sDA (DA300 lux), ASE, and DGP for the specific location of the City of Gainesville, Florida (latitude: 29.6516° N, longitude: 82.3248° W).

The optimization process was carried out using Galapagos, which is one of the Grasshopper's commands, providing “evolutionary computing” for the geometric variables of the building envelope system. Galapagos is a generic algorithm for optimization that uses a single objective optimization function. To optimize the shape, geometry, and orientation of the shading structure, following three performance parameters were used for the evaluation to the extent, simultaneously: 1) annual sun exposure (ASE) is minimized, 2) spatial daylight autonomy (sDA) is maximized, and 3) daylight glare probability (DGP) is minimized.

To generate a test case that includes these three objectives for optimization through Galapagos, these objectives were combined into a single objective function as follows. The governing equation for the objective function can be written as:

$${min f ( x )}_{x ∈ X} = {\sum }_{i = 1}^{n} ( rASE ) n + ( rSDA ) n + ( rDGP ) n = - 1 \qquad ( 2 )$$

$$Where :$$

$$rASE = \frac{( rASE ) n - 10}{100} = 0 \qquad ( 3 )$$

$$rsDA = - ( \frac{( rSDA ) n}{100} ) = - 1 \qquad ( 4 )$$

$$rDGP = \frac{( rDGP ) n - 0.35}{0.35} = 0 \qquad ( 5 )$$

The objective is to maintain the ASE at less than 10%; therefore, given the equation (3), the minimum ASE must be 0. As for the sDA, the greater the area percentage, the greater the sDA value. Therefore, according to equation (4), the minimum sDA must be −1. As mentioned elsewhere herein, “class A” DGP requires a value less or equal to 35%. By using equation (5), the minimum DGP is determined to be 0.

Therefore, the overall minimum value to be assigned to Galapagos, as indicated in equation (2), is:

$$( minimum ASE + minimum sDA + minimum DGP ) = - 1 \qquad ( 6 )$$

The optimized building envelope system for structures proximate the location of the mock-up structure, that is Gainesville, FL. FIG. 6A depicts the baseline structure and FIG. 6B depicts the baseline structure equipped with the building envelope system.

As described above, the optimum building envelope system, as determined from the iterative processes of simulating and optimizing was verified with a field experimental measurement on the mock up as also described above.

The simulation process was also fine-tuned with the modified geometry and using the dates of December 22 and June 22 (sun solstice dates) within the Rhinoceros environment utilizing Ladybug and Honeybee programs (the latest version of 1.3.5).

The computer model and the physical mock-up of the proposed building envelope system were used for daylight simulation and experiment, respectively, from June 20th to 27th, 2022 at 8 AM, 12 PM, and 4 PM.

Then, the simulation and experiment with the computer model and the physical mock-up (without the building envelope system) were conducted from June 28th to July 2nd, to compare the results of the proposed case with the control case.

### Results

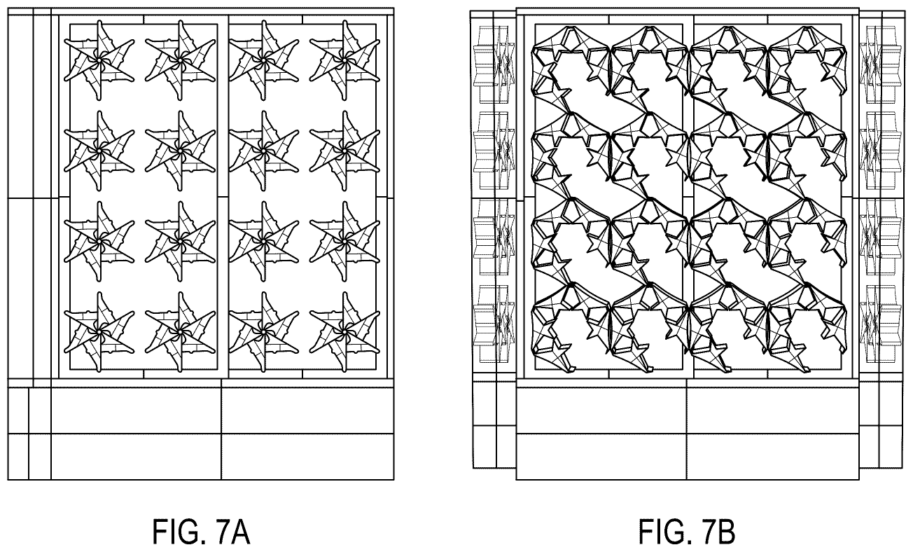

FIGS. 7A and 7B show the best-case scenario for the optimized building envelope system geometry. The geometry of the shading structure (the Galapagos result) produced the closest objective goal for a given number of geometry generations. FIG. 7A depicts the shading structure for a south-facing façade and FIG. 7B for the east/west façade. Note the shading modules demonstrate different geometric patterns for the south versus the east and west facades in response to the different orientations and resulting different sky conditions. This variety can be attributed to the simulation requirement to limit the sun exposure at noon, where the sun altitude is high (75° at noon on August 10) and limit the glare probability in the morning and afternoon, where the sun altitude is lower (13° at 8 AM on the same day).

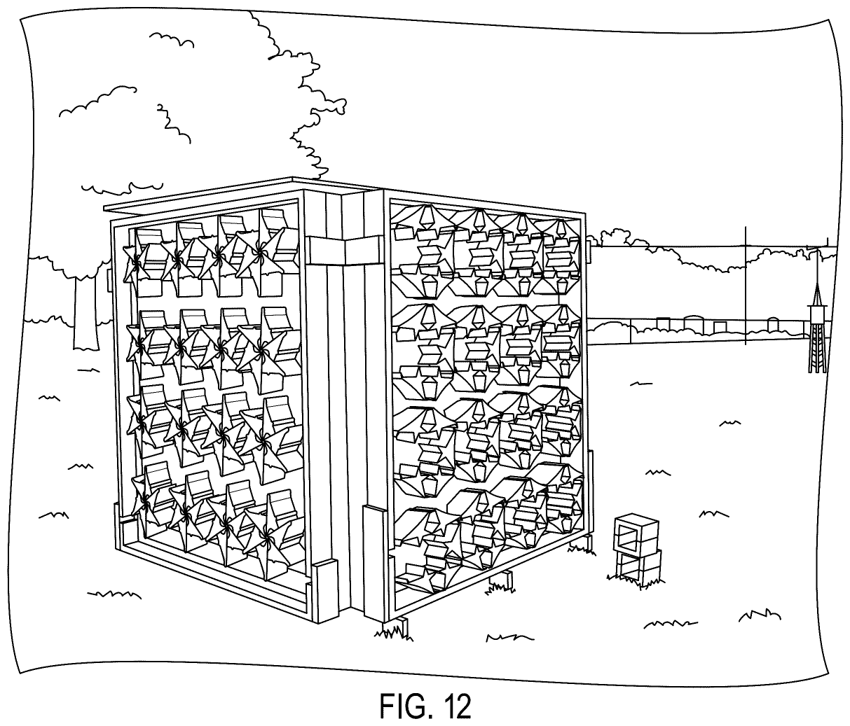

FIG. 12 illustrates two surfaces of the structure, with differently shaped modules on each surface. The use of differently shaped shading modules reflects the different compass orientations (that is, different facing directions, N, S, NW, SE, etc.) of these two surfaces.

### Horizontal Illuminance Analysis

For both the computer model and the physical mock-up, a 9-point grid (3×3) was made 0.3 m above the floor surface and the illuminance values were measured at that height. The illuminance analysis for both cases was followed by thermal analysis. Six thermal sensors were installed on the south, east, and west façade with three inside and three outside the structure. A thermal camera was used to measure the surface temperature on three façades for both inside and outside, thus six surface temperatures were measured at each designated time.

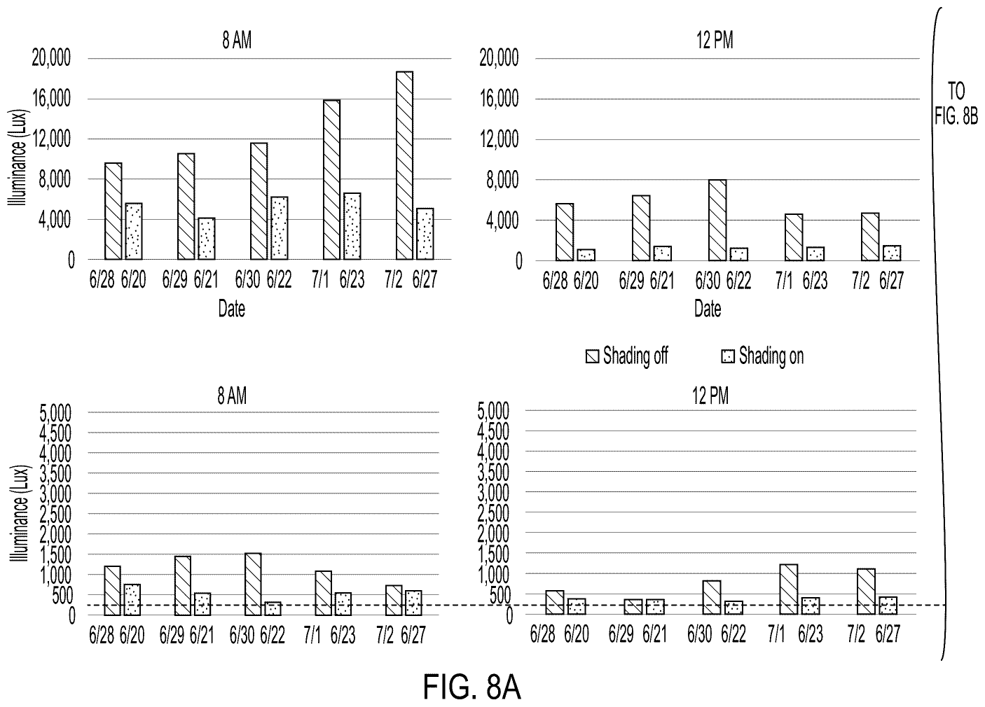

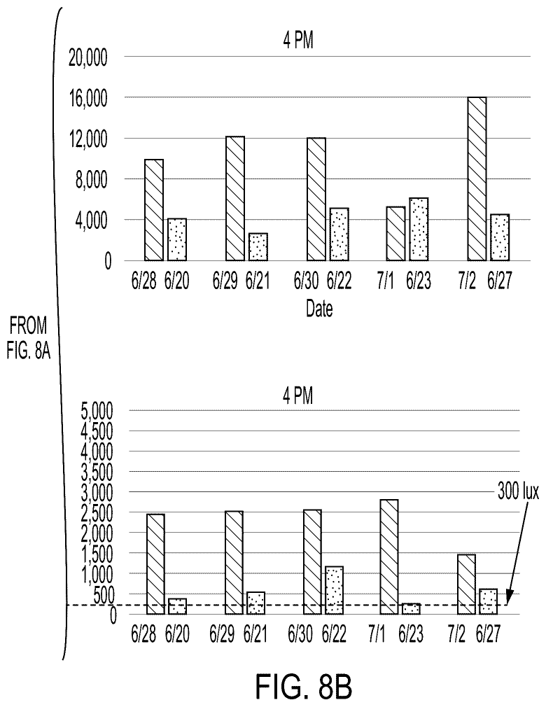

The horizontal illuminance levels were measured on a surface (0.3 m above the floor surface) for the simulation study, and then averaged for each study; the results are shown in FIGS. 8A-8B. According to the analysis result, it is evident that for most dates and time, for both studies, the shading has effectively reduced the illuminance levels when the shading modules were added. For simulation, the building envelope system was shown to have reduced the illuminance averaged for all by 58.6%, 76.4%, and 59.3% at 8 AM, 12 PM, and 4 PM, respectively (see Table 2 below).

As for the physical experiment, the data were collected for the aforementioned 9-point grid, and then averaged. The results indicated that the building envelope system was able to reduce the average illuminance by 53.0%, 54.8%, and 76.3% at 8 AM, 12 PM, and 4 PM, respectively (see Table 2).

Table 2 below reveals that the indoor average illuminance level, while being reduced due to the building envelope system, still largely remained with the range of 300-500 lux meeting the Illuminating Engineering Society's (IES) standards for an “office room” (Illuminating Engineering Society, 2020). The only lower illuminance level of 152.6 lux occurred on June 23rd at 4 PM, which can be attributed to the cloudy sky conditions (see FIG. 8).

TABLE 2
Illuminance analysis for simulation (top) and experiment (bottom)

Illuminance (Lux)
Shading

| | | | % of |
|---|---|---|---|
| Time | Shading off | Shading on | reduction |

| | | | | |
|---|---|---|---|---|
| 8 | AM | 13,284.87 | 5,502.24 | 58.6% |
| 12 | PM | 5,897.57 | 1,393.53 | 76.4% |
| 4 | PM | 11,060.69 | 4,500.09 | 59.3% |
| 8 | AM | 1,206.2 | 566.62 | 53.0% |
| 12 | PM | 823.2 | 372.04 | 54.5% |
| 4 | PM | 2,339.0 | 554.67 | 76.3% |

In summary, the building envelope system reduced the illuminance across the board by over 50% minimizing the probability of glare while still providing sufficient daylight-based illuminance for the space. For the simulation, the maximum shading effects of 76.4% happened at 12 PM, whereas in the experiment, the maximum shading effects of 76.3% took place at 4 PM in the afternoon.

### Thermal Analysis

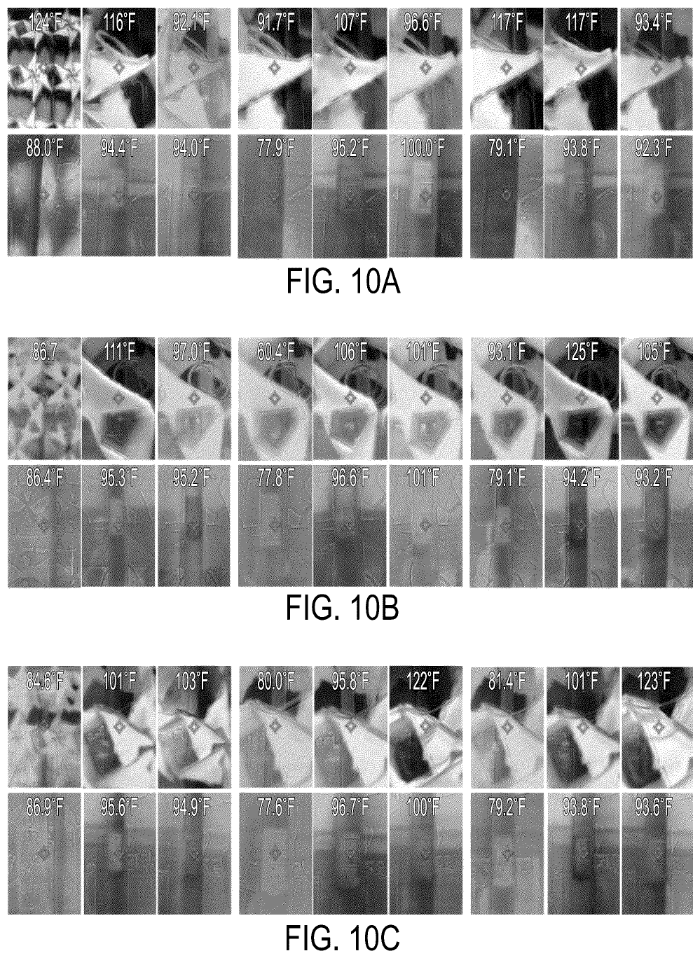

The effect of the proposed building envelope system on the thermal conditions, especially the indoor temperature, was evaluated using two indicators, namely, air temperature and surface temperature. The air temperature difference between inside and outside sensors (installed on the south, east and west facades) was used as a first indicator for thermal analysis, which relates to energy consumption. It is noteworthy that the physical mock-up was not equipped with an air-conditioning system nor did the mock-up include any natural ventilation capabilities, therefore, due to the greenhouse effect, the indoor air temperature was substantially higher than the outdoor temperature. The results of air temperature-based thermal analysis are presented in FIGS. 10A (east façade), 10B (south façade), and 10C (west façade), which shows that the delta temperature between indoor and outdoor is lower when the building envelope system is in use.

Regarding the comparison between the simulation results and on-site measurements, although the pattern of temperature increases and decreases with shading on and off is relatively consistent, there are several “outliers.” While providing precise explanation for such occurrences may not be feasible due to variances involved in thermal measurements as well as the possibility of air infiltration for the mock-up, the delta temperature anomaly on June 23rd was likely due to the cloudy weather. The corresponding illuminance level was unusually low (152.6 lux) for that day at 3 PM compared to other days (which were typically at 500 lux).

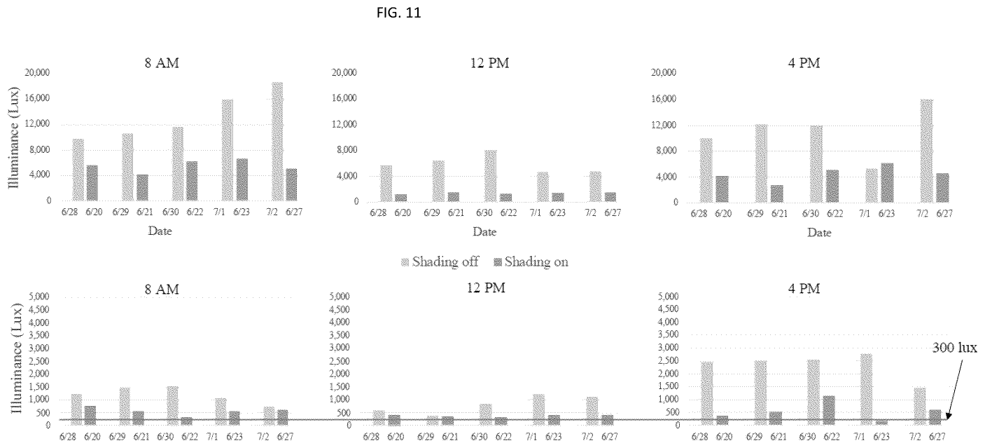

The surface temperature was chosen to experimentally investigate the effects of the building envelope system on indoor surface temperature and resulting thermal comfort. The surface temperature difference between inside and outside the physical mock-up (east, south, and west facades) was used as a second indicator for thermal analysis. Surface temperature measurements were conducted through thermal image camera (see the results in FIG. 11) at 1.8 m (6 ft.) above the floor level on the outside of the mock-up (outer layer of the shading modules) and corresponding location inside the mock-up. The experimental thermal imaging was conducted from June 22nd through June 27th, although a few days between those dates had to be excluded due to cloudy and rainy weather conditions that would have affected the measurements. Three random sunny dates including June 20th, June 22nd, and June 27th were selected to represent the effects of building envelope system on the surface temperature. The measurements were conducted at three times during the day, including 8 AM, 12 PM and 4 PM.

The thermal imaging results indicated that to a large extent the surface temperatures of the inside surfaces are considerably lower than the temperatures of the outside surfaces, effectively proving that a better thermal condition is provided, even for a hot location, such as Florida.

The results shown in FIG. 11 reveal that the building envelope system had significant reduction in indoor surface temperature for east, south, and west façades by 46.8%, 33.1%, and 32.3%, respectively, with the exception for the “outlier” being the west façade on June 23rd, which can, once again, be attributed to the cloudy weather that minimized the temperature difference between the outside and inside regions. As shown before, the corresponding illuminance level for the same date and time was also unusually low (152.6 lux), which further corroborates the above explanation.

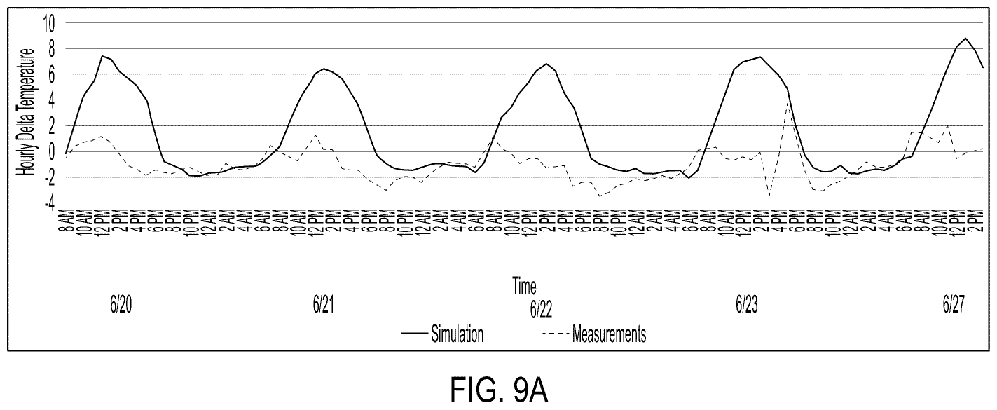

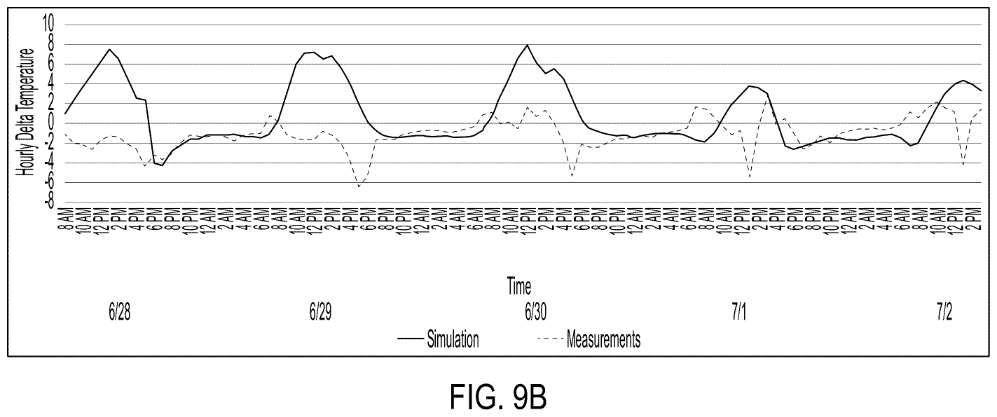

FIGS. 9 and 11 show a better indoor thermal performance in “shading on” cases, ensuring a lower heat transfer to the inside as the result of shading.

### Acoustical Performance

Due to the air volume contained in each structural module, the static embodiment of the system mitigates (e.g., reduces) the level of sound intensity (as measured in decibels) that reaches the interior space.

### Storm Protection

The shading modules provide additional support for the building envelope, and hence, mitigate the impact of wind load on the building envelope, in general, and the windows, in particular, which are more prone to structural damages during natural hazards, such as storms. While the inventor does not have experimental data on wind effects, it is intuitive that such extrusions (the shading modules) provide a layer of protection against external air flow, such as wind and especially high winds.

### Computer System Description

Certain aspects of the invention teach a method for designing shading modules that optimize certain IEQ parameters that are described herein. The shading modules for installing over fenestrations in a structure. An optimizing algorithm, including an objective function as described above, is employed to determine one or more of the shading module parameters, including: size, shape, geometry, orientation, number, placement, and material, that will optimize the IEQ parameters.

The optimization methodology of the invention can be executed in the context of computer-executable instructions, such as program modules, executed by a computer. Generally, program modules include routines, programs, objects, components, data structures, etc. that perform specific tasks or implement particular abstract data types. These software programs can be coded in different languages, for use with different processing platforms. It will be appreciated, however, that the principles that underlie the optimization process can be implemented with various types of computer hardware and software technologies.

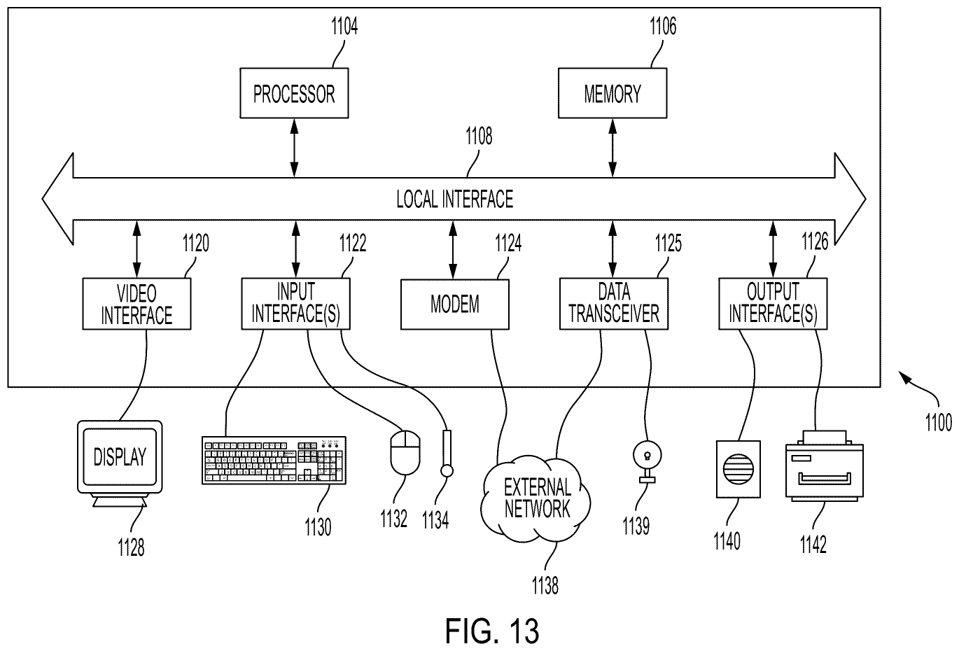

FIG. 13 illustrates a computer system 1100 for use in practicing the invention. The system 1100 can include multiple remotely-located computers and/or processors and/or servers (not shown). The computer system 1100 comprises one or more processors 1104 for executing instructions in the form of computer code to carry out a specified logic routine that implements the teachings of the present invention.

The computer system 1100 further comprises a memory 1106 for storing data, software, logic routine instructions, computer programs, files, operating system instructions, and the like, as is well known in the art. The memory 1106 can comprise several devices, for example, volatile and non-volatile memory components further comprising a random-access memory RAM, a read only memory ROM, hard disks, floppy disks, compact disks including, but not limited to, CD-ROM, DVD-ROM, and CD-RW, tapes, flash drives, cloud storage, and/or other memory components. The system 1100 further comprises associated drives and players for these memory types.

In a multiple computer embodiment, the processor 1104 comprises multiple processors on one or more computer systems linked locally or remotely. According to one embodiment, various tasks associated with the present invention may be segregated so that different tasks can be executed by different computers/processors/servers located locally or remotely relative to each other.

The processor 1104 and the memory 1106 are coupled to a local interface 1108. The local interface 1108 comprises, for example, a data bus with an accompanying control bus, or a network between a processor and/or processors and/or memory or memories. In various embodiments, the computer system 1100 further comprises a video interface 1120, one or more input interfaces 1122, a modem 1124 and/or a data transceiver interface device 1125. The computer system 1100 further comprises an output interface 1126. The system 1100 further comprises a display 1128. The graphical user interface referred to above may be presented on the display 1128. The system 1100 may further comprise several input devices (some which are not shown) including, but not limited to, a keyboard 1130, a mouse 1131, a microphone 1132, a digital camera, smart phone, a wearable device, and a scanner (the latter two not shown). The data transceiver 1125 interfaces with a hard disk drive 1139 where software programs, including software instructions for implementing the present invention are stored.

The modem 1124 and/or data receiver 1125 can be coupled to an external network 1138 enabling the computer system 1100 to send and receive data signals, voice signals, video signals and the like via the external network 1138 as is well known in the art. The system 1100 also comprises output devices coupled to the output interface 1126, such as an audio speaker 1140, a printer 1142, and the like.

This Description of the Invention is not to be taken or considered in a limiting sense, and the appended claims, as well as the full range of equivalent embodiments to which such claims are entitled define the scope of various embodiments. This disclosure is intended to cover any and all adaptations, variations, or various embodiments. Combinations of presented embodiments, and other embodiments not specifically described herein by the descriptions, examples, or appended claims, may be apparent to those of skill in the art upon reviewing the above description and are considered part of the current invention.

What is claimed is:

1. A building envelope system comprising:
a plurality of shading modules for installing over one or more fenestrations of a structure, wherein at least one of a size, shape, geometry, orientation, number, placement, and material of each shading module of the plurality of shading modules is determined based on optimizing one or more indoor environmental quality parameters for a geographical location of the structure and for the one or more fenestrations.

2. The building envelope system of claim 1, comprising an optimization algorithm for optimizing the one or more indoor environmental quality parameters, wherein the one or more indoor environmental quality parameters comprise maximizing spatial daylight autonomy (SDA), minimizing annual sun exposure (ASE), and minimizing daylight glare probability.

3. The building envelope system of claim 2, wherein the optimization algorithm minimizes transfer of acoustical energy from outside the structure to inside the structure.

4. The building envelope system of claim 1, wherein the one or more indoor environmental quality parameters comprises interior illuminance levels, interior surface temperatures, mitigation of heat transfer through the building envelope system, visual comfort, environmental comfort, and acoustical performance.

5. The building envelope system of claim 1, wherein one or more of a size, shape, geometry, orientation, number, placement, and material of each shading module of the plurality of shading modules is selected responsive to climatological parameters at a location of the structure.

6. The building envelope system of claim 5, wherein the climatological parameters comprise average air temperature, surface temperature, operative temperature, and solar radiation, wherein the operative temperature comprises an average of the air and surface temperatures.

7. The building envelope system of claim 1, wherein the geographical location comprises a latitude of the structure.

8. The building envelope system of claim 1, wherein each one of the plurality of shading modules resist wind-blown objects and limits heat transfer through the plurality of shading modules.

9. The building envelope system of claim 1, wherein each one of the plurality of shading modules comprise a closed structural shape further comprising a plurality of interconnected geometric elements.

10. The building envelope system of claim 9, wherein each one of the plurality of interconnected structural elements comprises a triangle.

11. The building envelope system of claim 1, wherein the fenestration comprises a window, a door, or another surface having different thermal transmittance or light transmittance properties than other regions of the structure.

12. The building envelope system of claim 1, wherein a size, shape, geometry, orientation, number, placement, and material of each one of the plurality of shading modules is dependent on the compass direction of the fenestration.

13. The building envelope system of claim 1, wherein the structure comprises a plurality of surfaces each having a different compass direction, and wherein identically-shaped shading modules are installed on the one or more fenestrations in one of the plurality of surfaces.

14. The building envelope system of claim 1, wherein a material of one or more of the shading modules of the plurality of shading modules comprises aluminum.

15. The building envelope system of claim 1, wherein a plurality of shading modulus on a first surface of the structure comprises differently shaped modules on a second surface of the structure, the first and second surfaces having a different compass direction.

16. The building envelope system of claim 1, wherein one or both of an area covered by the plurality of shading modules and the shape of each shading module of the plurality of shading modules is determined by a facing direction of a surface of the structure on which the plurality of shading modules is mounted.

17. The building envelope system of claim 1, wherein each one of the plurality of shading modules is spaced apart from the fenestration such that air between the fenestration and each one of the plurality of shading modules provides insulative properties.

18. The building envelope system of claim 1, wherein a material and placement of each shading module of the plurality of shading modules reduces wind load exerted on the fenestrations of the structure.

19. A non-transitory computer readable medium containing instructions that when executed by a processor perform acts comprising:
optimizing one or more indoor environmental quality parameters by determining one or more structural parameters of each shading module of a plurality of shading modules to be installed over fenestrations in a structure, wherein the structural parameters comprise a size, shape, geometry, orientation, number, placement, and material, and further considering a geographical location of the structure and a compass direction of each fenestration.

20. The non-transitory computer readable medium of claim 1, wherein the one or more indoor environmental quality parameters comprise maximizing spatial daylight autonomy (SDA), minimizing annual sun exposure (ASE), and minimizing daylight glare probability.
